(19) United States
(12) Patent Application Publication
(10) Pub. No.: US 2025/0111037 A1
(43) Pub. Date: Apr. 3, 2025

(54) SYSTEM FOR EXTRACTING MALWARE CAPABILITIES AND METHOD THEREOF

(71) Applicant: INDIAN INSTITUTE OF TECHNOLOGY KANPUR, KANPUR (IN)

(72) Inventors: BIKASH SAHA, KANPUR (IN); NANDA RANI, KANPUR (IN); SANDEEP KUMAR SHUKLA, KANPUR (IN)

(21) Appl. No.: 18/812,003

(22) Filed: Aug. 22, 2024

(30) Foreign Application Priority Data
Sep. 29, 2023 (IN) 202311065488

(51) Int. Cl. G06F 21/53; G06F 21/57

(52) U.S. Cl. CPC G06F 21/53; G06F 21/577; G06F 2221/034

(57) ABSTRACT

The present invention discloses a system and method for extracting malware capability. The system comprises a malware execution subsystem configured to execute a malware application in an isolated computing environment, detect one or more changes in system instances and obtain one or more system application programming interface (API) calls and their execution timestamp data from the executed malware application, a malware activity capturing subsystem configured to sort the system API calls based on the obtained timestamp data, generate a trigram sequence from the sorted system API calls, process the trigram sequence to generate one or more feature vectors, a malware capability extraction subsystem configured to classify the received feature vectors based on one or more malignant capabilities of the executed malware and generate a threat report based on analysis of the classified malignant capabilities of the executed malware.

### EARLIEST PRIORITY DATE

This Application claims priority from a Provisional patent application filed in India having patent application Ser. No. 20/231,1065488, filed on Sep. 29, 2023, and titled “SYSTEM FOR EXTRACTING MALWARECAPABILITIES AND METHOD THEREOF”.

### FIELD OF INVENTION

Embodiments of the present invention relate to cybersecurity and more particularly relate to a system and method for extracting malware capabilities to capture and analyse the malignant characteristics of malware.

### BACKGROUND

The traditional domain of cybersecurity primarily focuses on the detection and categorization of malware, typically assigning new malware specimens to known families based on defining characteristics. While this approach effectively highlights dominant malware capabilities, it often fails to fully unravel the spectrum of capabilities and threats posed by malicious software.

A notable trend in malware evolution is the rise of advanced persistent threats (APTs) and other sophisticated attack methods. Adversaries are increasingly deploying intricate and intelligent malware designed to execute multiple harmful actions within a single framework, known as multipurpose malware. This shift necessitates innovative cybersecurity approaches and threat mitigation strategies.

Traditional behavioural analysis often provides a high-level overview of malware actions but may not delve deep into uncovering complex malware's concealed capabilities. Cybersecurity experts often rely on manual analysis to understand malware behaviour fully. This process is time-consuming, resource-intensive, and may not scale well due to large malware samples. Traditional methods often struggle to identify and understand multipurpose malware that performs multiple malicious actions simultaneously. Currently, no single method is available that effectively extracts all malignant capabilities from complex malware. Many products available in the market for malware analysis and detection rely on traditional methods that primarily concentrate on detecting malware and assigning the malware to a specific family. These approaches provide insights into the dominant capability of the malware but often overlook the intelligence related to its complete array of malignant capabilities.

The existing technology for extracting intelligence from raw data (malware in this case) using malware analysis involves static, dynamic, and hybrid analysis. However, using all these analysis methods, analysts either manually extract only a single dominant capability or implement a multi-class automated classification method. Available state-of-the-art focuses on getting a dominant capability rather than listing all capabilities infused within a single, sophisticated malware. To obtain a range of inbuilt malignant capabilities from a single malware requires a classification method that may classify within more than one class (capability in this case) for any given input sample (malware in this case).

Hence, there is a need for a system and method of extracting malignant capabilities of malware, to address the aforementioned issues.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with one embodiment of the present invention disclosure, a system for extracting malware capabilities is disclosed. The system comprises a system for determining malignant capabilities of one or more malwares, the system comprising one or more hardware processors and a memory coupled to the one or more hardware processors, wherein the memory comprises a plurality of subsystem executable by the one or more hardware processors, and wherein the plurality of subsystems comprises a malware execution subsystem configured to execute a malware application in an isolated computing environment detect one or more changes in system instances, upon execution of the malware application in the isolated computing environment and obtain one or more system application programming interface (API) calls and their execution timestamp data from the executed malware application, a malware activity capturing subsystem operatively coupled to the malware execution subsystem configured to sort the system application programming interface (API) calls based on the obtained timestamp data, generate, by a trigram technique, a trigram sequence from the sorted system API calls, process, by one hot encoding technique, the trigram sequence to generate one or more feature vectors, a malware capability extraction subsystem operatively coupled to the malware activity capturing subsystem configured to classify, by a multi-label deep neural network (DNN), the received feature vectors based on one or more malignant capabilities of the executed malware and generate a threat report based on analysis of the classified malignant capabilities of the executed malware.

In an embodiment, the malware capability extraction subsystem comprises receiving the one or more feature vectors, grouping the received one or more feature vectors with historical behavioural instances to generate training samples and training the multi-label deep neural network.

In one aspect, a method for determining malignant capabilities of one or more malwares is disclosed. The method comprising executing a malware application in an isolated computing environment, detecting, one or more changes in system instances, upon execution of the malware application in the isolated computing environment, obtaining, one or more system application programming interface (API) calls and their execution time stamp data from the executed malware application, sorting, the system application programming interface (API) calls based on the obtained timestamp data, generating, a trigram sequence from the sorted system API calls, processing, the trigram sequence of system API calls to generate one or more feature vectors, classifying, by a multi-label deep neural network (DNN), the received feature vectors based on one or more malignant capabilities of the executed malware, and generating, a threat report based on the analysis of the classified malignant capabilities of the executed malware.

In an embodiment, classifying, by the multi-label deep neural network (DNN), the received feature vectors based on one or more malignant capabilities of the executed malware, comprising receiving the one or more feature vectors, grouping the received one or more feature vectors with historical behavioural instances to generate training samples and training the multi-label deep neural network (DNN), based on the training samples, for extraction of the malignant capabilities of the executed malware

To further clarify the advantages and features of the present invention, a more particular description of the invention will follow by reference to specific embodiments thereof, which are illustrated in the appended figures. It is to be appreciated that these figures depict only typical embodiments of the invention and are therefore not to be considered limiting in scope. The invention will be described and explained with additional specificity and detail with the appended figures.

### BRIEF DESCRIPTION OF THE DRAWINGS

The disclosure will be described and explained with additional specificity and detail with the accompanying figures in which:

FIG. 1 illustrates a block diagram an exemplary network architecture of a system for extracting malware capabilities, in accordance with an embodiment of the present invention;

FIG. 2 illustrates an exemplary block diagram representation of the system, in accordance with an embodiment of the present invention;

FIG. 3 illustrates an exemplary flow diagram depicting the system for extracting malware capabilities, in accordance with an embodiment of the present invention; and

FIG. 4 illustrates a flow chart of a method for extracting malware capabilities, in accordance with an embodiment of the present invention.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE PRESENT INVENTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

A computer system (standalone, client or server computer system) configured by an application may constitute a “module” (or “subsystem”) that is configured and operated to perform certain operations. In one embodiment, the “module” or “subsystem” may be implemented mechanically or electronically, so a module includes dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed permanently configured (hardwired) or temporarily configured (programmed) to operate in a certain manner and/or to perform certain operations described herein.

Embodiments of the present invention relate to a system for extracting malware capabilities to capture and analyse the malignant characteristics of malware.

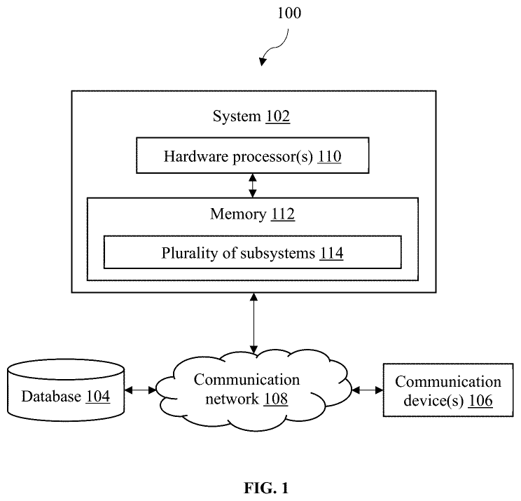

Referring now to the drawings, and more particularly to FIG. 1 through FIG. 4, where similar reference characters denote corresponding features consistently throughout the figures, there are shown preferred embodiments, and these embodiments are described in the context of the following exemplary system and/or method.

The present invention describes a novel approach for extraction of hidden malware capabilities. This system has the capability to identify the list of malignant activities, i.e., capabilities a malware can perform when executed in a computer system. Also, as the current malware analysis methods are primarily based on multi-class or binary solutions, accordingly they fail to predict the entire set of target labels (capabilities) hidden within a single input sample (malware). The present invention fills this gap by identifying multiple hidden target labels (capabilities) as an output.

FIG. 1 illustrates an exemplary block diagram representation of a network architecture 100 of a system 102 for extracting malware capabilities, in accordance with an embodiment of the present invention.

According to an embodiment of the present disclosure, the network architecture 100 may include the system 102, a database 104, and one or more communication devices 106. The system 102 may be communicatively coupled to the database 104, and the one or more communication devices 106 via a communication network 108. The communication network 108 may be a wired communication network and/or a wireless communication network, a local area network (LAN), a wide area network (WAN), a metropolitan area network (MAN), a telephone network, such as the public switched telephone network (PSTN) or a cellular network, an intranet, an internet, a fibre optic network, a satellite network, a cloud computing network, or a combination of networks.

The database 104 may include, but is not limited to, storing, and managing malware samples that are executed and analysed within the system 102. The database 104 manages and organizes malware behaviour reports generated by the system 102 during malware execution. The malware behaviour reports contain valuable insights into the actions and malignant capabilities of the analysed malware. The database 104 is configured to hold information related to the features extracted from the malware behaviour reports. The features are crucial for the subsequent analysis and identification of the malware capabilities. The database 104 is configured to support the functionality of the system 102 and enables efficient data retrieval and storage for various aspects associated with malignant capabilities from complex malwares to develop appropriate and efficient countermeasures to mitigate and prevent malicious attacks by the malware. The database 104 may be any kind of database such as, but are not limited to, bank databases, relational databases, dynamic databases, monetized databases, scalable databases, cloud databases, distributed databases, any other databases, and a combination thereof. The one or more communication devices 106 may be digital devices, computing devices, and/or networks. The one or more communication devices 106 may include, but is not limited to, a mobile device, a smartphone, a personal digital assistant (PDA), a tablet computer, a phablet computer, a wearable computing device, a virtual reality/augmented reality (VR/AR) device, a laptop, a desktop, and the like.

One or more hardware processors 110 may include, for example, microprocessors, microcomputers, microcontrollers, digital signal processors, central processing units, state machines, logic circuits, and/or any devices that manipulate data or signals based on operational instructions. Among other capabilities, the one or more hardware processors 110 may fetch and execute computer-readable instructions in a memory 112 operationally coupled with the system 102 for performing tasks such as data processing, input/output processing, and/or any other functions. Any reference to a task in the present disclosure may refer to an operation being or that may be performed on data. The memory 112 comprises a plurality of subsystems 114 in the form of programmable instructions executable by the one or more hardware processors 110.

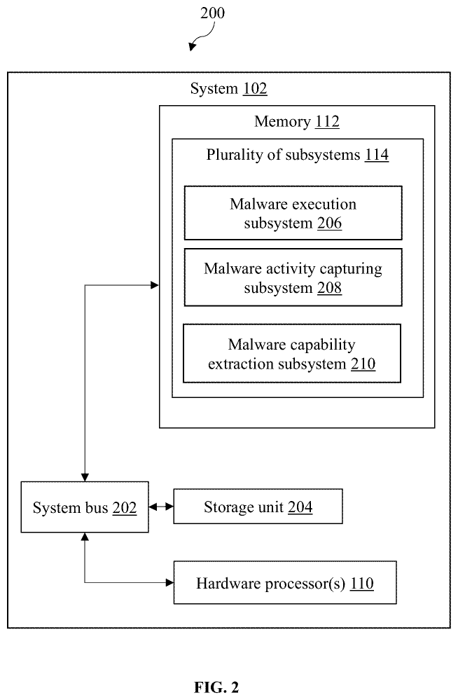

FIG. 2 illustrates a block diagram 200 representation of the system 102 for extracting malware capabilities, in accordance with an embodiment of the present invention.

In an exemplary embodiment, the system 102 comprises the one or more hardware processors 110, the memory 112, and a storage unit 204. The one or more hardware processors 110, the memory 112, and the storage unit 204 are communicatively coupled through a system bus 202 or any similar mechanism. The system 102 is configured to extract all malignant capabilities from complex malwares. The malware includes, but not limited to, viruses, worms, trojans, ransomware, spyware, adware, and the like.

The malignant capabilities refer to the harmful or malicious functions, actions, or abilities possessed by a software or program, such as malware. The malignant capabilities are designed to cause damage, compromise security, steal data, or perform other malicious activities on a computer system or network. In the context of malware, malignant capabilities encompass the full range of actions that the malware may execute when introduced into the one or more communication devices 106, and they are typically concealed to evade detection. The malignant capabilities may include, but not limited to, activities like process injection capability, an anti-debugging capability, a scanning capability, a discover running processes, a crypto ransomware, an evasion capability, an alter configuration capability, an installed software exploration capability, a registry modification capability, a service impairment capability and a spying capability over the one or more communication devices 106.

In an embodiment, the plurality of subsystems 114 comprises a malware execution subsystem 206. The malware execution subsystem 206 executes a malware application in an isolated computing environment, effectively establishing an isolated computational ecosystem. The sandbox environment is instrumental in executing the malware within a secure and isolated computational ecosystem, thereby confining the malignant actions solely within the boundaries of the malware execution subsystem 206. A sandbox agent, serves as an operative entity, is tasked with continuously monitoring and transmitting behavioural data about the executing malicious attacks instance that are orchestrated in the sandbox environment.

Upon execution of the malware application in the isolated sandbox environment, one or more system instances are detected by the malware execution subsystem 206. The detected changes in the system instances can be, but not limited to, a system configuration change, a file system change, a process and memory change, a network configuration change, a user account and permission change, a software and application change, data exfiltration and encryption changes etc. On detection of change in the system interface by the malware execution subsystem 206, the system application programming interfaces (API) calls and their execution timestamp data are obtained. These system API calls indicate the service or resource requests raised by the executed malware application from the operating system (OS).

In an embodiment, the plurality of subsystem 114 further comprises a malware activity capturing subsystem 208. The malware activity capturing subsystem 208 is operatively coupled to the malware execution subsystem 206. The malware activity capturing subsystem 208 is configured to undertake a range of sophisticated tasks to comprehensively analyse malignant activities by the malware. The malware activity capturing subsystem 208 receives the system API calls and the timestamp data obtained by the malware execution subsystem 206 and sorts the system API calls based on the timestamp data. The sorted system API calls are transformed using a trigram technique to generate unique trigram sequences. In the trigram technique, the sorted system API calls are split into tokens consisting of three consecutive system API calls. These tokens are called unique trigram sequences.

The generated trigram sequence is processed using a one hot encoding technique to generate feature vectors. In the one hot encoding technique, each unique trigram sequence is converted into a binary vector representation. Firstly, all unique trigrams sequences in the dataset are identified and a unique index is assigned to each of them. Then, binary vector for each trigram is created, where the vector's length equals the total number of unique trigrams. Finally, the index corresponding to the trigram is assigned as 1, indicating its presence, and all other indices are assigned as 0. The encoded sequence is the feature vector representation of the trigrams.

In an exemplary embodiment, the malware capability extraction subsystem 210 is operatively coupled to the malware activity capturing subsystem 208. The malware capability extraction subsystem 210 is configured to subject the feature vector, which encapsulates the transformed data representing the malign behaviours of the malicious attacks, to further in-depth analysis. The malware capability extraction subsystem 210 employs a multi-label deep neural network (DNN) to classify the feature vectors based on its malignant capabilities of the executed malware. The malignant capabilities of the executed malware capabilities can be a process injection capability, an anti-debugging capability, a scanning capability, a discover running processes, a crypto ransomware, an evasion capability, an alter configuration capability, an installed software exploration capability, a registry modification capability, a service impairment capability and a spying capability. The classified malignant capability of the executed malware is then analysed to generate a threat report.

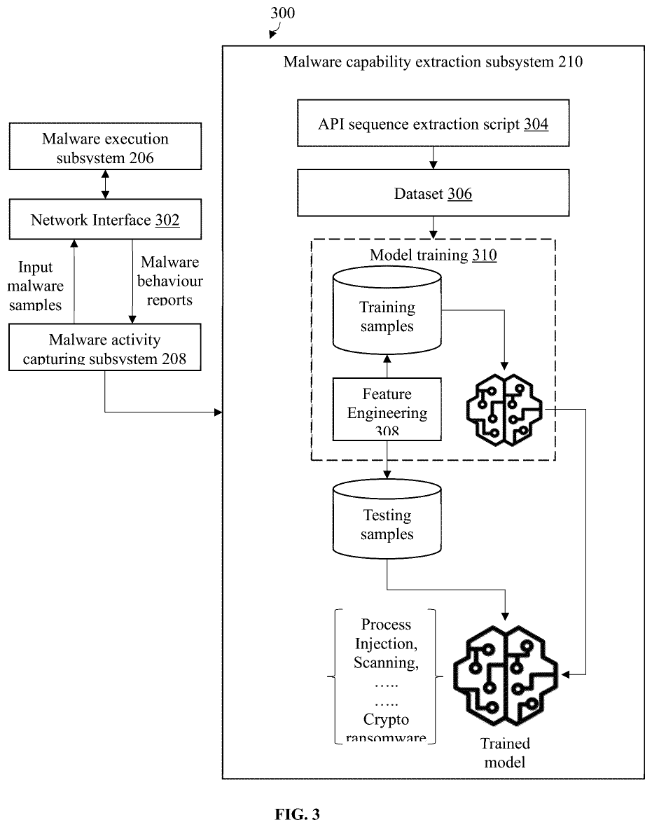

FIG. 3 illustrates an exemplary flow diagram 300 depicting the system 102 for extracting malware capabilities, in accordance with an embodiment of the present invention.

In the malware capability extraction subsystem 210, an API sequence extraction script 304 receives the sequences of system API calls made by the malware during the malware execution. These sequences, combined with the historical dataset 306, are sent to the model training 310. The system 102 further employs a feature engineering 308 to prepare the training samples, which are essential for training the DNN to understand malware behaviour. The set of samples are divided into the 70:30 ratio as training samples and testing samples. The historical dataset may consist of at least one of historical system API calls, historical timestamp data and historical training sample sets.

The malware capability extraction subsystem 210 then feeds the training samples to the machine learning model to train the DNN. The DNN applies multi-label classification, to identify multiple hidden target labels (capabilities) for each of the training sample. Once DNN model is trained, the malware capability subsystem 210 uses the testing samples to evaluate the DNN model's performance. This trained DNN model is utilized for classifying the malignant capabilities of the executed malware.

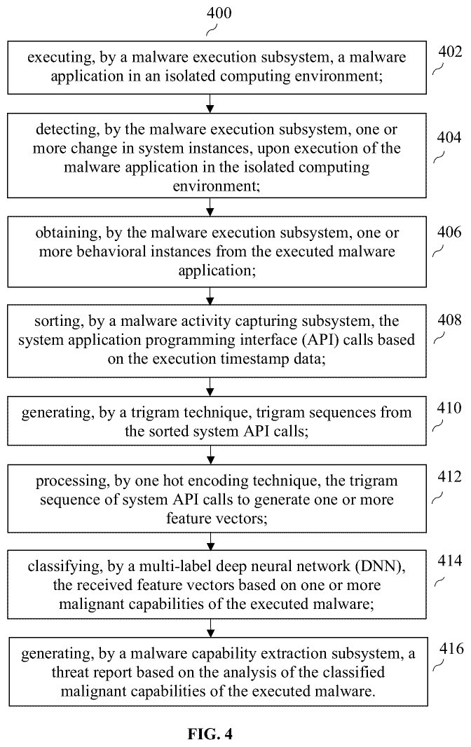

FIG. 4 illustrates a flow chart of a method for extraction of malware capabilities, in accordance with an embodiment of the present invention.

At step 402, a malware application is executed in an isolated computing environment.

At step 404, one or more changes in system instances is detected, upon execution of the malware application in the isolated computing environment.

At step 406, one or more system application programming interface (API) calls and their execution time stamp data from the executed malware application are obtained.

At step 408, the system application programming interface (API) calls is sorted based on the obtained timestamp data.

At step 410, a trigram sequence is generated from the sorted system API calls by a trigram technique.

At step 412, the trigram sequence of system API calls is processed to generate one or more feature vectors by one hot encoding technique.

At step 414, the received feature vectors are classified based on one or more malignant capabilities of the executed malware by a multi-label deep neural network (DNN).

At step 416, a threat report is generated based on the analysis of the classified malignant capabilities of the executed malware.

In yet another embodiment, the classification of the received feature vectors, further comprises receiving the one or more feature vectors, grouping the received one or more feature vectors with historical behavioural instances to generate training samples and training the multi-label deep neural network (DNN), based on the training samples, for extraction of the malignant capabilities of the executed malware.

Numerous advantages of the present disclosure may be apparent from the discussion above. The system assists the cybersecurity professionals in prioritizing incident response efforts based on the severity of the identified plurality of malware capabilities. This prioritization ensures that the most critical malware is addressed promptly, reducing the risk of widespread damage. Additionally, understanding the intent behind the malignant capabilities of the malware aids in constructing more effective response strategies. Also, the cybersecurity professionals utilize the data gathered by the system to identify trends in malicious development and capabilities over time. This historical perspective enables the cybersecurity professionals to anticipate future threats and devise proactive security measures. By recognizing evolving attack vectors, the organizations may stay one step ahead of cybercriminals.

Furthermore, the use of the DNN in the malware capability extraction subsystem enhances the accuracy of malignant capabilities identification, thereby enhancing the overall efficacy of malware analysis and malignant capabilities identification. All in all, the ability to identify malware capabilities streamlines incident response immediately and accurately. This reduction in response time by the system significantly mitigates the impact of the malware, minimizing data breaches, system disruptions, and financial losses.

While specific language has been used to describe the invention, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A system for determining malignant capabilities of one or more malwares, the system comprising:
one or more hardware processors; and
a memory coupled to the one or more hardware processors, wherein the memory comprises a plurality of subsystem executable by the one or more hardware processors, and wherein the plurality of subsystems comprises:
a malware execution subsystem configured to:
execute a malware application in an isolated computing environment;
detect one or more changes in system instances, upon execution of the malware application in the isolated computing environment; and
obtain one or more system application programming interface (API) calls and executed timestamp data from the executed malware application;
a malware activity capturing subsystem operatively coupled to the malware execution subsystem configured to:
sort the system application programming interface (API) calls based on the obtained timestamp data;
generate, by a trigram technique, a trigram sequence from the sorted system API calls;
process, by one hot encoding technique, the trigram sequence to generate one or more feature vectors;
a malware capability extraction subsystem operatively coupled to the malware activity capturing subsystem configured to:
classify, by a multi-label deep neural network (DNN), the received feature vectors based on one or more malignant capabilities of the executed malware; and
generate a threat report based on analysis of the classified malignant capabilities of the executed malware.

2. The system as claimed in claim 1, wherein the malware capability extraction subsystem further comprises:
receiving the one or more feature vectors;
grouping the received one or more feature vectors with historical behavioral instances to generate training samples; and
training the multi-label deep neural network (DNN), based on the training samples, for extraction of the malignant capabilities of the executed malware.

3. The system as claimed in claim 1, wherein the established isolated computing environment is a sandbox environment.

4. The system as claimed in claim 1, wherein the one or more malignant capabilities of the executed malware comprises at least one of a process injection capability, an anti-debugging capability, a scanning capability, a discover running processes, a crypto ransomware, an evasion capability, an alter configuration capability, an installed software exploration capability, a registry modification capability, a service impairment capability and a spying capability.

5. A method for determining malignant capabilities of one or more malwares, the method comprising:
executing, by a malware execution subsystem, a malware application in an isolated computing environment;
detecting, by the malware execution subsystem, one or more changes in system instances, upon execution of the malware application in the isolated computing environment;
obtaining, by the malware execution subsystem, one or more system application programming interface (API) calls and executed time stamp data from the executed malware application;
sorting, by a malware activity capturing subsystem, the system application programming interface (API) calls based on the obtained timestamp data;
generating, by a trigram technique, a trigram sequence from the sorted system API calls;
processing, by one hot encoding technique, the trigram sequence of system API calls to generate one or more feature vectors;
classifying, by a multi-label deep neural network (DNN), the received feature vectors based on one or more malignant capabilities of the executed malware; and
generating, by a malware capability execution subsystem, a threat report based on the analysis of the classified malignant capabilities of the executed malware.

6. The method as claimed in claim 5, wherein classifying, by the multi-label deep neural network (DNN), the received feature vectors based on one or more malignant capabilities of the executed malware, further comprises:
receiving the one or more feature vectors;
grouping the received one or more feature vectors with historical behavioral instances to generate training samples; and
training the multi-label deep neural network (DNN), based on the training samples, for extraction of the malignant capabilities of the executed malware.

7. The method as claimed in claim 5, wherein the established isolated computing environment is a sandbox environment.

8. The method as claimed in claim 5, wherein the one or more malignant capabilities of the executed malware comprises at least one of a process injection capability, an anti-debugging capability, a scanning capability, a discover running process, a crypto ransomware, an evasion capability, an alter configuration capability, an installed software exploration capability, a registry modification capability, a service impairment capability, and a spying capability.
